(19) United States
(12) Patent Application Publication
(10) Pub. No.: US 2025/0189664 A1
(43) Pub. Date: Jun. 12, 2025

(54) MEASUREMENT GRID EFFICIENCY FOR DYNAMIC OCCUPANCY GRID COMPUTATION

(71) Applicant: QUALCOMM Incorporated, San Diego, CA (US)

(72) Inventors: James POPLAWSKI, Canton, MI (US); Makesh Pravin JOHN WILSON, San Diego, CA (US); Thomas MERICHKO, Royal Oak, MI (US); Vishnuu APPAYA DHANABALAN, Munich (DE)

(21) Appl. No.: 18/975,853

(22) Filed: Dec. 10, 2024

Related U.S. Application Data
(60) Provisional application No. 63/609,079, filed on Dec. 12, 2023.

(51) Int. Cl. G01S 13/931; G01S 13/86

(52) U.S. Cl. CPC G01S 13/931; G01S 13/867; G01S 2013/93271

(57) ABSTRACT

An occupancy grid updating method includes: obtaining, at an apparatus from at least one sensor, a plurality of measurements of a plurality of objects; identifying, at the apparatus and based on the plurality of measurements, first occupancy grid cells having occupancy mass corresponding to the plurality of objects; identifying, at the apparatus and based on the plurality of measurements, second occupancy grid cells that are unoccupied; and updating, at the apparatus, an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

### CROSS-REFERENCE TO RELATED APPLICATIONS

This application claims the benefit of U.S. Provisional Application No. 63/609,079, filed Dec. 12, 2023, entitled “MEASUREMENT GRID EFFICIENCY FOR DYNAMIC OCCUPANCY GRID COMPUTATION,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow.

A driver assistance system may mitigate driving risk for a driver of an ego vehicle (i.e., a vehicle configured to perceive the environment of the vehicle) and/or for other road users. Driver assistance systems may include one or more active devices and/or one or more passive devices that can be used to determine the environment of the ego vehicle and, for semi-autonomous vehicles, possibly to notify a driver of a situation that the driver may be able to address. The driver assistance system may be configured to control various aspects of driving safety and/or driver monitoring. For example, a driver assistance system may control a speed of the ego vehicle to maintain at least a desired separation (in distance or time) between the ego vehicle and another vehicle (e.g., as part of an active cruise control system). The driver assistance system may monitor the surroundings of the ego vehicle, e.g., to maintain situational awareness for the ego vehicle. The situational awareness may be used to notify the driver of issues, e.g., another vehicle being in a blind spot of the driver, another vehicle being on a collision path with the ego vehicle, etc. The situational awareness may include information about the ego vehicle (e.g., speed, location, heading) and/or other vehicles or objects (e.g., location, speed, heading, size, object type, etc.).

A state of an ego vehicle may be used as an input to a number of driver assistance functionalities, such as an Advanced Driver Assistance System (ADAS). Downstream driving aids such as an ADAS may be safety critical, and/or may give the driver of the vehicle information and/or control the vehicle in some way.

### SUMMARY

An example occupancy grid updating method includes: obtaining, at an apparatus from at least one sensor, a plurality of measurements of a plurality of objects; identifying, at the apparatus and based on the plurality of measurements, first occupancy grid cells having occupancy mass corresponding to the plurality of objects; identifying, at the apparatus and based on the plurality of measurements, second occupancy grid cells that are unoccupied; and updating, at the apparatus, an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

An example apparatus includes: at least one memory; at least one sensor; and at least one processor, communicatively coupled to the at least one memory and the at least one sensor, configured to: obtain, from the at least one sensor, a plurality of measurements of a plurality of objects; identify, based on the plurality of measurements, first occupancy grid cells having occupancy mass corresponding to the plurality of objects; identify, based on the plurality of measurements, second occupancy grid cells that are unoccupied; and update an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

Another example apparatus includes: means for obtaining, from at least one sensor, a plurality of measurements of a plurality of objects; means for identifying, based on the plurality of measurements, first occupancy grid cells having occupancy mass corresponding to the plurality of objects; means for identifying, based on the plurality of measurements, second occupancy grid cells that are unoccupied; and means for updating an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

An example non-transitory, processor-readable storage medium includes processor-readable instructions to cause at least one processor of an apparatus to: obtain, from at least one sensor, a plurality of measurements of a plurality of objects; identify, based on the plurality of measurements, first occupancy grid cells having occupancy mass corresponding to the plurality of objects; identify, based on the plurality of measurements, second occupancy grid cells that are unoccupied; and update an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is an example occupancy grid map with an ego vehicle and detected objects.

FIG. 10 is the occupancy grid shown in FIG. 9, with an occupancy mass influencing region surrounding each object, and free space regions between the ego vehicle and nearest objects.

FIG. 11 is the occupancy grid shown in FIG. 10, with the free space regions merged.

FIG. 12 is a block diagram of analysis cells of the occupancy grid shown in FIG. 9, with the analysis cells divided into sectors.

FIG. 13 is a block diagram of analysis cells of the occupancy grid shown in FIG. 9, with the analysis cells assigned to processor work units.

FIG. 14 is a block flow diagram of an occupancy grid updating method.

### DETAILED DESCRIPTION

Techniques are discussed herein for determining occupancy grids. For example, measurements from one or more sensors, e.g., including one or more radars and/or one or more cameras, may be obtained and measurements therefrom used to determine a dynamic occupancy grid. Techniques are discussed for detecting objects and determining occupancy grid cells having occupancy mass corresponding to the detected objects, and for determining occupancy grid cells that are free space candidates, being between an ego vehicle and a nearest detected object for a given angle relative to the ego vehicle. The cells having mass corresponding to the detected objects and the free space candidate cells may be selected for occupancy grid processing. These cells may be divided, e.g., evenly, between processor work units. These examples, however, are not exhaustive, and other techniques may be used.

A measurement for initializing or updating a dynamic occupancy grid may be computationally costly and take a lot of time if each cell in a measurement grid is individually computed and the full measurement grid is fused without consideration of whether there is activity in a particular cell. As discussed herein, polygons may be generated to sectorize only those areas of the measurement grid where sensor measurements are to be used to update the state of the fused grid. These sectorized areas may represent regions of computed free space and/or regions that have been determined by the sensor(s) to be occupied. The measurement update of the dynamic occupancy grid algorithm chain may process only grid cells that fall within these polygons. Classification of static and dynamic objects may be identified by later stages of the dynamic occupancy grid algorithm chain. The dynamic occupancy grid algorithm chain may take into account map and v2x (vehicle-to-everything) information in addition to the onboard sensor.

Items and/or techniques described herein may provide one or more of the following capabilities, as well as other capabilities not mentioned. Occupancy grid determination may be improved, e.g., by reducing processing power and/or time to compute an occupancy grid (or occupancy grid update) compared to present techniques. Autonomous driving actions and/or autonomous driving safety may be improved, e.g., due to reduced occupancy grid computation time. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

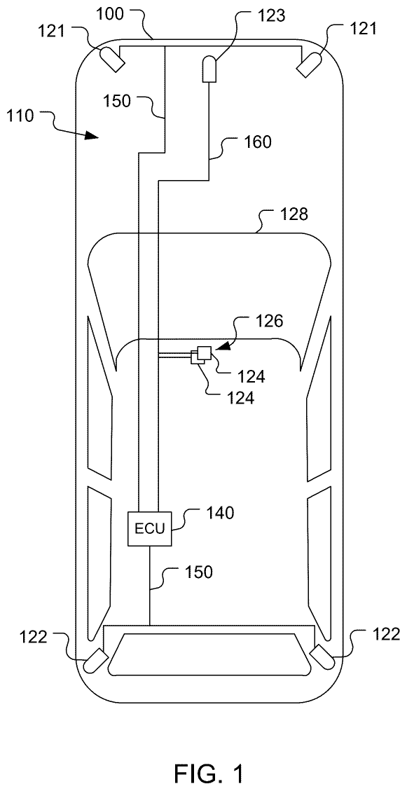

Referring to FIG. 1, an ego vehicle 100 includes an ego vehicle driver assistance system 110. The driver assistance system 110 may include a number of different types of sensors mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle 100, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121, 122 may include an LRR and/or an SRR (Short-Range Radar). The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

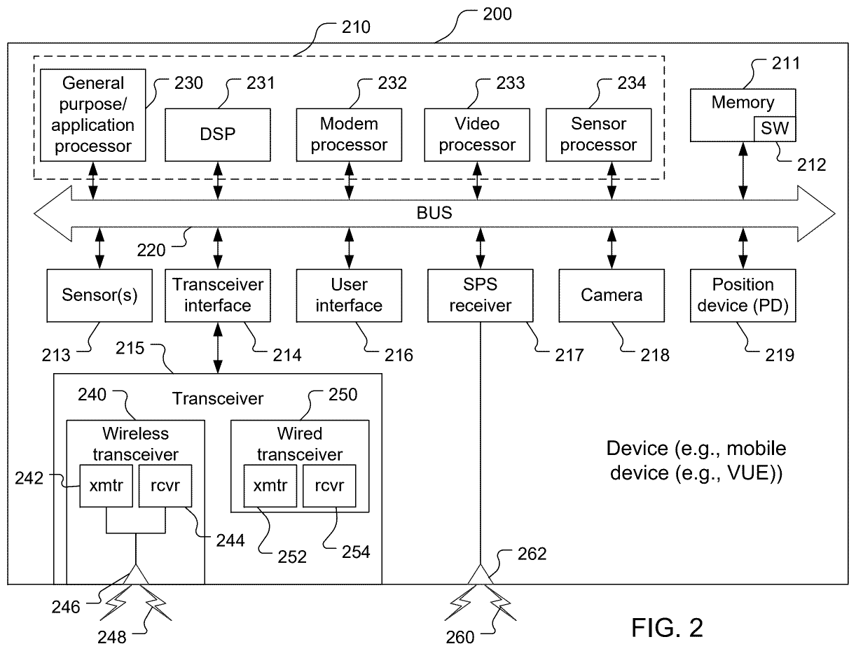

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The terms “user equipment” or “UE” (or variations thereof) are not specific to or otherwise limited to any particular Radio Access Technology (RAT), unless otherwise noted. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of another object (e.g., another device) with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a coverage area of a serving base station and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

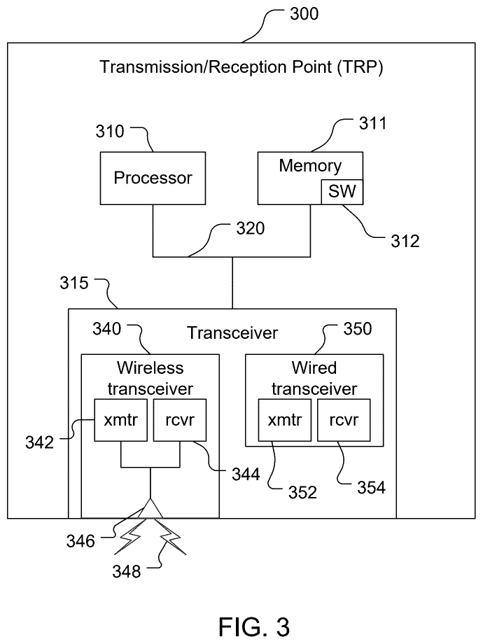

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. Even if referred to in the singular, the processor 310 may include one or more processors, the transceiver 315 may include one or more transceivers (e.g., one or more transmitters and/or one or more receivers), and/or the memory 311 may include one or more memories. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

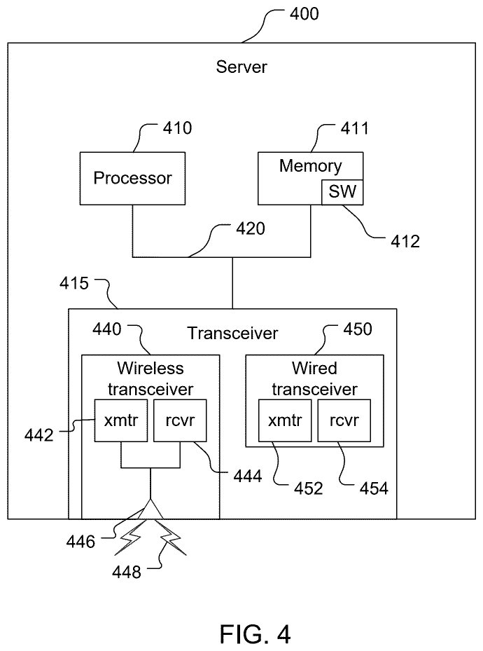

Referring also to FIG. 4, a server 400, of which an LMF is an example, may comprise a computing platform including a processor 410, memory 411 including software (SW) 412, and a transceiver 415. Even if referred to in the singular, the processor 410 may include one or more processors, the transceiver 415 may include one or more transceivers (e.g., one or more transmitters and/or one or more receivers), and/or the memory 411 may include one or more memories. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

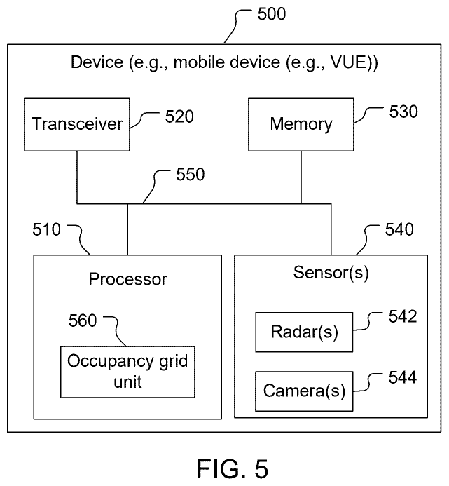

Referring to FIG. 5, a device 500 includes a processor 510, a transceiver 520, a memory 530, and one or more sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. The sensor(s) 540 include one or more radar sensors 542 and/or one or more cameras 544 and/or one or more other types of sensors (e.g., lidar, acoustic sensor, etc.).

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy grid unit 560 (which may include an ADAS (Advanced Driver Assistance System) for a VUE). The occupancy grid unit 560 is discussed further herein, and the description herein may refer to the occupancy grid unit 560 performing one or more functions, and/or may refer to the processor 510 generally, or the device 500 generally, as performing any of the functions of the occupancy grid unit 560, with the device 500 being configured to perform the functions.

One or more functions performed by the device 500 (e.g., the occupancy grid unit 560) may be performed by another entity. For example, sensor measurements (e.g., radar measurements, camera measurements (e.g., pixels, images)) and/or processed sensor measurements (e.g., a camera image converted to a bird's-eye-view image) may be provided to another entity, e.g., the server 400, and the other entity may perform one or more functions discussed herein with respect to the occupancy grid unit 560 (e.g., using machine learning to determine a present occupancy grid and/or applying an observation model, analyzing measurements from different sensors, to determine a present occupancy grid, etc.).

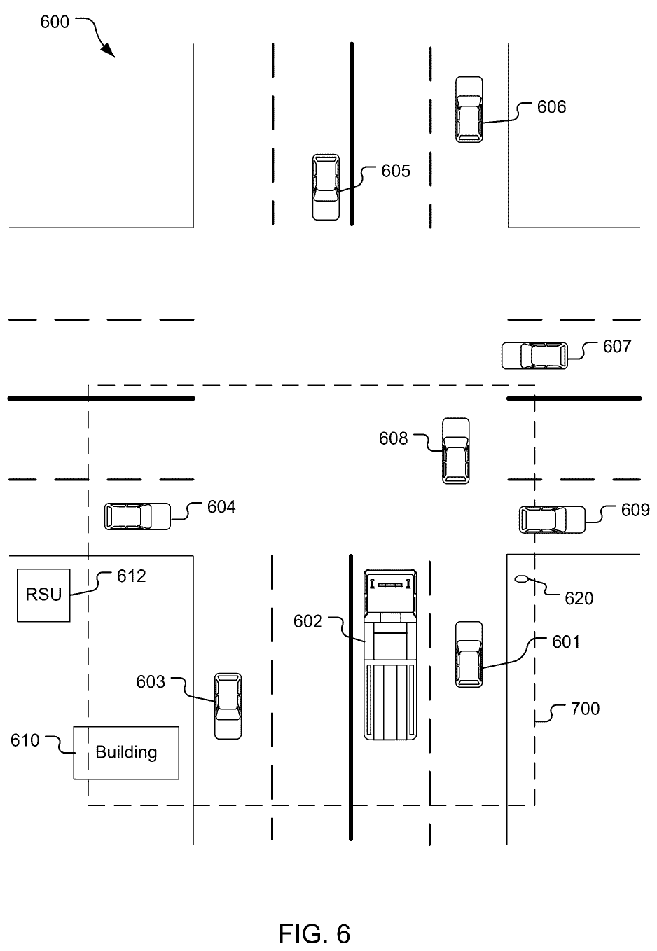

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type or class (bicycle, car, truck, etc.), etc.).

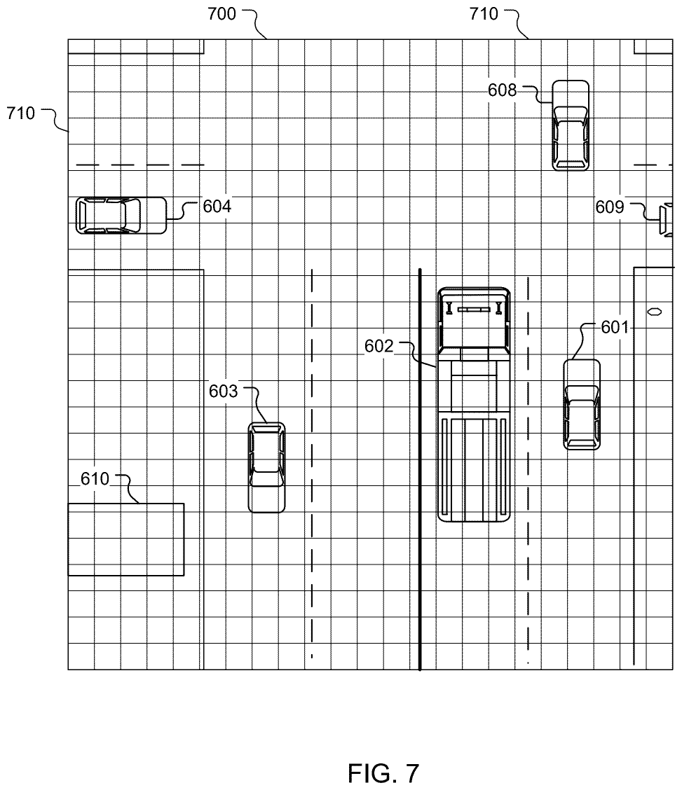

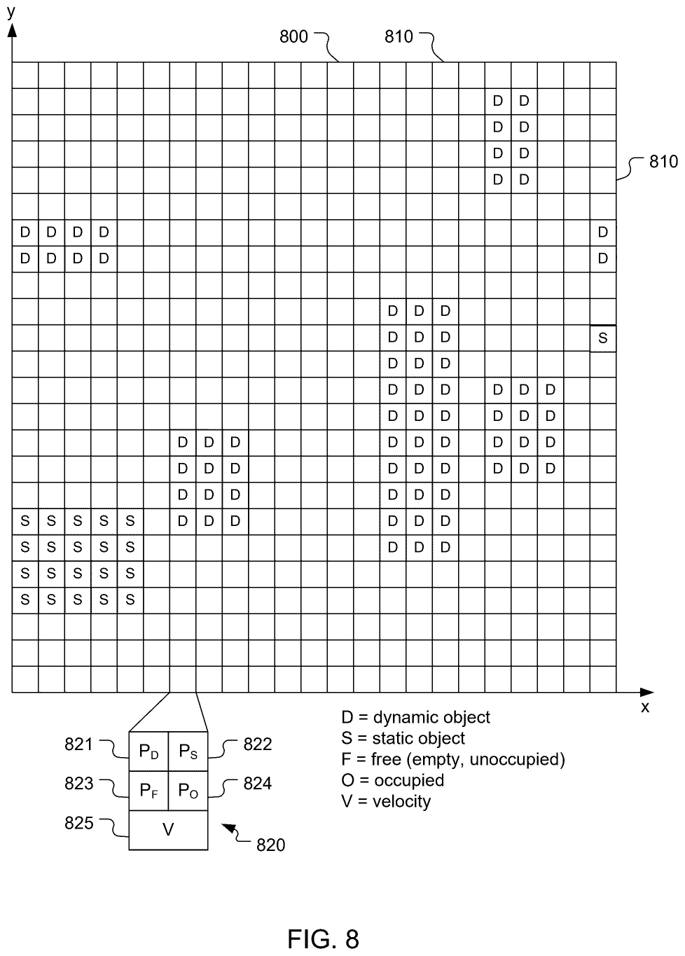

Referring also to FIGS. 7 and 8, a region 700, which in this example spans a portion of the environment 600, may be evaluated to determine an occupancy grid 800 (also called an occupancy map) that indicates multiple probabilities for each cell of the grid 800 whether the cell is occupied or free, and whether an occupying object is static or dynamic. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub-regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8). As another example, a grid may comprise a 512×512 array of sub-regions. Still other implementations of occupancy grids may be used.

Each of the sub-regions 710 may correspond to a respective cell 810 of the occupancy map and information may be obtained regarding what, if anything, occupies each of the sub-regions 710 and whether an occupying object is static or dynamic in order to populate cells 810 of the occupancy grid 800 with probabilities of the cell being occupied (O) or free (F) (i.e., unoccupied), and probabilities of an object at least partially occupying a cell being static (S) or dynamic (D). Each of the probabilities may be a floating point value. The information as to what, if anything, occupies each of the sub-regions 710 may be obtained from a variety of sources. For example, occupancy information may be obtained from sensor measurements from the sensor(s) 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include a set 820 of occupancy information indicating a dynamic probability 821 (P_{D}), a static probability 822 (P_{S}), a free probability 823 (P_{F}), an occupied probability 824 (P_{P}), and a velocity 825 (V). The dynamic probability 821 indicates a probability that an object (if any) in the corresponding sub-region 710 is dynamic. The static probability 822 indicates a probability that an object (if any) in the corresponding sub-region 710 is static. The free probability 823 indicates a probability that there is no object in the corresponding sub-region 710. The occupied probability 824 indicates a probability that there is an object in (any portion of) the corresponding sub-region 710. Each of the cells 810 may include respective probabilities 821-824 of an object corresponding to the cell 810 being dynamic, static, absent, or present, with a sum of the probabilities being 1. In the example shown in FIG. 8, cells more likely to be free (empty) than occupied are not labeled in the occupancy grid 800 for sake of simplicity of the figure and readability of the occupancy grid 800. Also as shown in FIG. 8, cells more likely to be occupied than free, and occupied by an object that is more likely to be dynamic than static are labeled with a “D”, and cells more likely to be occupied than free, and occupied by an object that is more likely to be static than dynamic are labeled with a “S”. An ego vehicle may not be able to determine whether a cell is occupied or not (e.g., being behind a visible surface of an object and not discernable based on an observed object (e.g., if the size and shape of a detected object is unknown)), and such a cell may be labeled as unknown occupancy.

Building a dynamic occupancy grid (an occupancy grid with a dynamic occupier type) may be helpful, or even essential, for understanding an environment (e.g., the environment 600) of an apparatus to facilitate or even enable further processing. For example, a dynamic occupancy grid may be helpful for predicting occupancy, for motion planning, etc. A dynamic occupancy grid may, at any one time, comprise one or more cells of static occupier type and/or one or more cells of dynamic occupier type. A dynamic object may be represented as a set of one or more velocity vectors. For example, an occupancy grid cell may have some or all of the occupancy probability be dynamic, and within the dynamic occupancy probability, there may be multiple (e.g., four) velocity vectors each with a corresponding probability that together sum to the dynamic occupancy probability for that cell 810. A dynamic occupancy grid may be obtained, e.g., by the occupancy grid unit 560, by processing information from one or more sensors, e.g., of the sensor(s) 540, such as from a radar system.

To build a dynamic occupancy grid (DoG), the device 500, e.g., the occupancy grid unit 560, may determine a measurement grid. Determining the measurement grid is a computationally-intensive operation. To determine the measurement grid, sensor measurements from the sensor(s) 540 may be used to compute and assign occupancy and/or free space masses to some of the cells in an occupancy grid. The sensor measurements contain sufficient information from which the occupancy grid unit 560 may determine which cells in a grid are candidates for occupancy or free space masses. For example, object detections from the sensor measurements may provide all the information needed to determine which cells in a grid are candidates for occupancy or free space masses.

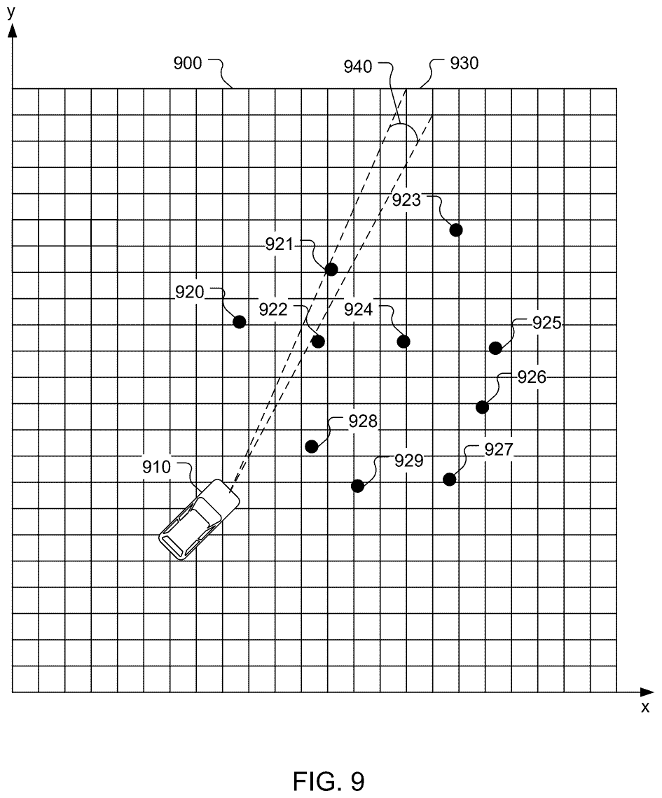

Referring also to FIG. 9, an occupancy grid 900 is provided for an environment that includes an ego vehicle 910 (which may be an example of the device 200 or which may include an example of the device 500), and objects 920, 921, 922, 923, 924, 925, 926, 927, 928, 929. The occupancy grid 900 comprises a two-dimensional grid of cells 930 (e.g., a 512×512 grid of cells although only a 23×23 grid of cells is shown). To determine parameters for each cell of the occupancy grid 900, iteration may be performed over every cell in a measurement grid corresponding to the occupancy grid 900. Iteration may be performed for every detected object whose angular position falls in an angular extent of the cell (for which iteration is being performed). For example, a cell 930 has an angular extent 940 relative to the ego vehicle 910, with the angular extent 940 covering (including) at least a portion of each of the objects 921, 922. Thus, for the cell 930, iteration may be performed for the objects 921, 922 to determine whether detection of the object 921 and/or detection of the object 922 contributes occupancy mass to the cell 930. If it is determined that either of the objects 921, 922 contributes occupancy mass to the cell 930, then the occupancy mass contribution(s) may be determined. This process may be repeated for all the cells of the measurement grid. If a cell under analysis is determined to be closer to the ego vehicle 910 (e.g., closer to the sensor(s) making the object detections) than the nearest object detection (the nearest detected object) in the angular extent of the cell under analysis, then the occupancy mass for that cell may be determined to be free space. All the cells of the measurement grid may be distributed, e.g., equally (such as nearly as equally as possible), across multiple processor work units of a processor of the ego vehicle 910. Occupancy mass may be updated for cells presently influenced by a detected object, and cells previously (e.g., most recently) influenced by a detected object but now occupied by free space. In this case, many cells may require little processing as the cells will not receive an occupancy mass update, and thus the processing load may not be well balanced across the processor work units.

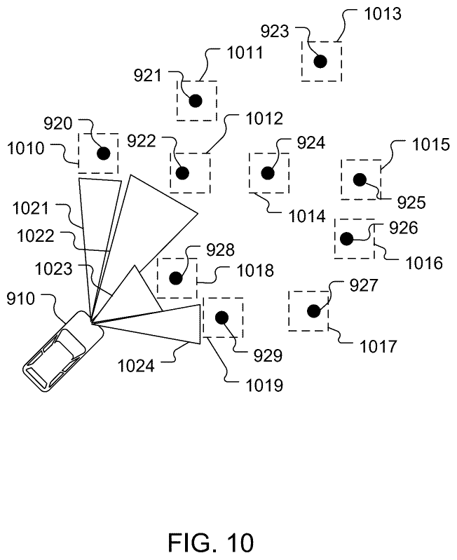

Referring also to FIG. 10 the occupancy grid unit 560 may limit the measurement grid cells to be assessed to (e.g., may only process measurements for) those cells that are candidates for free space or occupancy masses (e.g., not process celled labeled as being occluded). This may improve efficiency of computation of the occupancy grid, which may save processing power and/or processing time, which may help improve any use of the occupancy grid, e.g., for autonomous driving decisions. For example, the occupancy grid unit 560 may compute cell indices that will receive occupancy mass from each object detection as well as the occupancy mass values. Each object detection may have a surrounding region that will have occupancy mass influenced by the detected object. For example, the objects 920-929 have surrounding regions 1010, 1011, 1012, 1013, 1014, 1015, 1016, 1017, 1018, 1019 of occupancy mass influence. The occupancy grid unit 560 may determine the occupancy mass contributed by each object to each cell with which the corresponding surrounding region overlaps. The occupancy grid unit 560 may store the determined occupancy mass values for these cells in a mini-grid. The occupancy grid unit 560 may determine whether each object detection is a closest detection to the sensor(s) making the object detection for an angular extent corresponding to the object. This angular extent may be configured as any of a variety of angular extents (e.g., a configurable angle, or an angle corresponding to the cell(s) in which the object is detected, or to the surrounding region of the object, or to the cells overlapped by the surrounding region, etc.). If the occupancy grid unit 560 determines that an object detection is a closest detection, to the sensor(s) making the object detection, for an angular extent corresponding to the object, then the occupancy grid unit 560 may compute and store a polygon corresponding to the angular extent and the nearest object detection in that angular extent. Each polygon may have any of a variety of shapes (e.g., a triangle, a rectangle, etc.) and different polygons may have different shapes. Each polygon represents a free space candidate zone for the corresponding object detection. As shown, in this example, the occupancy grid unit 560 may determine four triangular regions 1021, 1022, 1023, 1024 as free space candidate zones corresponding to detections of the objects 920, 922, 928, 929, respectively.

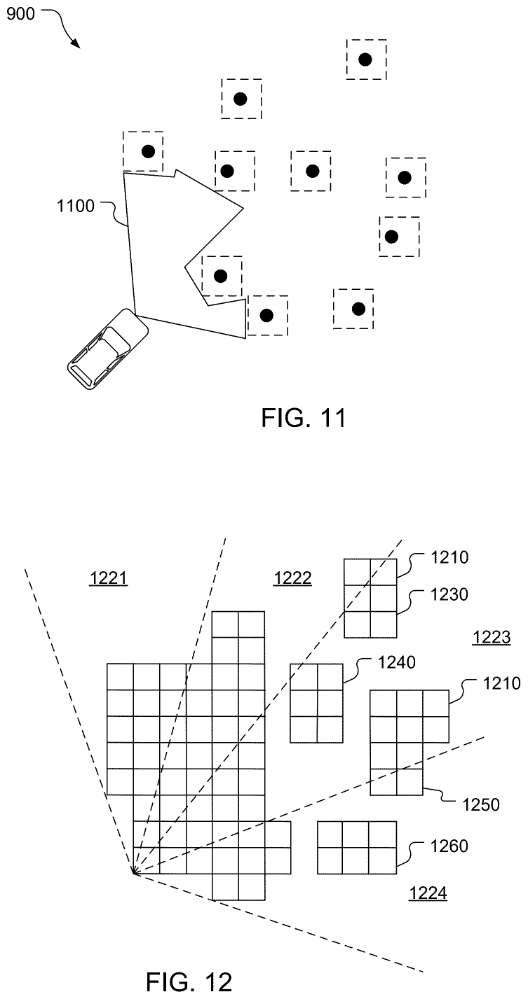

Referring also to FIG. 11, the occupancy grid unit 560 may use free space candidate zones, here the free space candidate zones 1021-1024, to define a total region 1100 polygon of the occupancy grid 900 where free space mass will exist. The occupancy grid unit 560 may determine all the cells of the measurement grid that overlap with the total region 1100 to define the free space cells to be analyzed for updating the occupancy grid 900 (e.g., updating the occupancy mass values for the occupancy grid 900). A line algorithm may be used to fill the total region 1100, e.g., starting from a center to an object detection, or from a boundary to an object detection. Line algorithms (e.g., Bresenham's line algorithm) are methods for determining what cells in a grid (or pixels in a digital image) best represent a defined line in the grid. By running a line algorithm between the sensor location in the grid and the positions of cells in the grid representing measurement detections, a list of cells in the grid that represent free space (and thus are to be captured by polygon regions) can be determined.

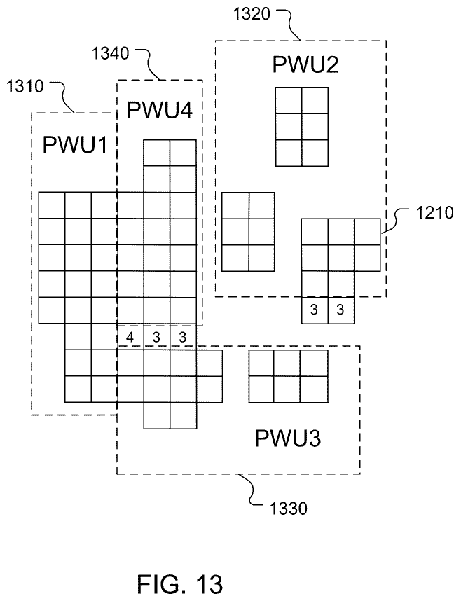

Referring also to FIGS. 12 and 13, the occupancy grid unit 560 may determine and distribute a subset of cells of the measurement grid for analysis for updating occupancy grid mass values. The occupancy grid unit 560 may determine analysis cells 1210 as the cells overlapping the total region (e.g., the total region 1100) plus the cells overlapping with the surrounding regions (e.g., the surrounding regions 1010-1019) (i.e., the cells of the mini-grids such as mini-grids 1230, 1240, 1250, 1260). The occupancy grid unit 560 may distribute the analysis cells across multiple processor work units (e.g., GPU (General Processing Unit) work units) of the processor 510 for determining occupancy mass values. For example, the occupancy grid unit 560 may load balance the analysis cells 1210 (which may be called candidate cells) over multiple processor work units. The occupancy grid unit 560 may evenly distribute (e.g., attempt to evenly distribute, or evenly distribute as best as possible) the analysis cells 1210 over available processor work units. For example, the occupancy grid unit 560 may divide the analysis cells 1210 into non-overlapping sectors (relative to the ego vehicle) of equal (e.g., approximately equal) work effort, here into four regions 1221, 1222, 1223, 1224 of cells. As another example, the occupancy grid unit 560 may divide the total number of the analysis cells 1210 by the number of processor work units and assign equal quantities (e.g., as best as possible) of the analysis cells 1210 to the processor work units. For example, as shown in FIG. 13, for four processor work units the occupancy grid unit 560 may assign the analysis cells 1210 in a region 1310 to a first processor work unit (PWU1), assign the analysis cells 1210 in a region 1320 to a second processor work unit (PWU2), assign the analysis cells 1210 in a region 1330 and four other of the analysis cells 1210 (each containing the number “3”) to a third processor work unit (PWU3), and assign the analysis cells 1210 in a region 1340 and one other analysis cell 1210 (containing the number “4”) to a fourth processor work unit (PWU4). In this example, the first processor work unit is assigned 21 of the analysis cells 1210, and the second, third, and fourth processor work units are each assigned 20 of the analysis cells 1210. Determining and distributing analysis cells by work effort differs from an approach where all occupancy grid cells are assessed for measurement grid information, which may result in uneven, inefficient workloads over the processor work units because many cells may not have any occupancy mass or may have free space mass for a given sensor update, e.g., for a given set of measurements from one of the sensor(s) 540. Determining and distributing analysis cells by work effort may help prevent memory conflicts between different processor work units. One or more parameters, such as a quantity of processor work units used to analyze measurement grid cells, and/or a quantity of sectors into which to divide measurement grids to be analyzed, etc., may be based on one or more factors such as available compute capacity, operational design domain (ODD) (e.g., urban vs. highway), and/or number of object detections, etc. In some scenarios, more work units may be used than in other scenarios, e.g., based on a present scenario. Not all available processor work units may be used for measurement grid analysis. The processor work units may be assigned measurement grid cells unevenly, e.g., one work unit may be assigned 10% of measurement grid cells to be analyzed while three other work units may each be assigned 30% of the measurement grid cells to be analyzed. This may be done, for example, where one processor work unit has some available capacity but less than 100% capacity available.

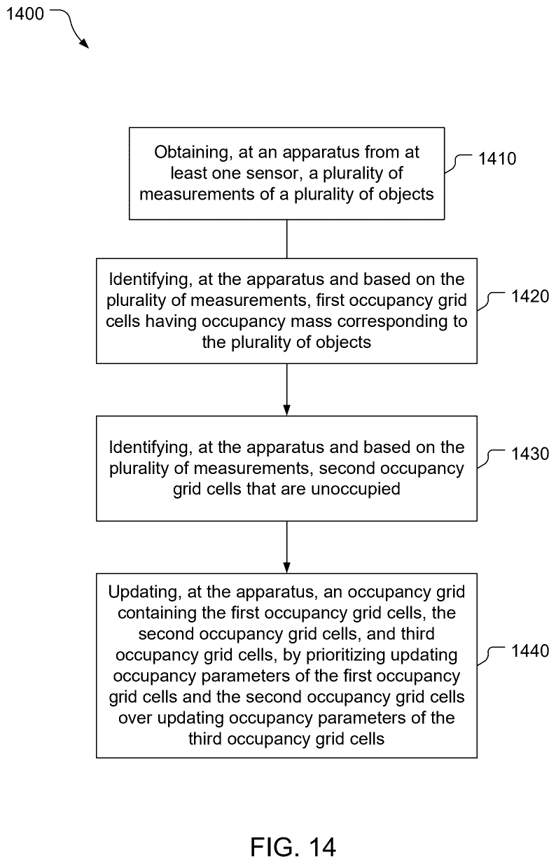

Referring to FIG. 14, with further reference to FIGS. 1-13, an occupancy grid updating method 1400 includes the stages shown. The method 1400 is, however, an example only and not limiting. The method 1400 may be altered, e.g., by having stages added, removed, rearranged, combined, performed concurrently, and/or having single stages split into multiple stages.

At stage 1410, the method 1400 includes obtaining, at an apparatus from at least one sensor, a plurality of measurements of a plurality of objects. For example, one or more of the sensor(s) 540 may make measurements of objects (e.g., the objects 920-929). The measurements may be of one or more types, e.g., radar measurement, image, etc. One or more of the sensor(s) 540, possibly in combination with the processor 510, possibly in combination with the memory 530, may comprise means for obtaining the plurality of measurements.

At stage 1420, the method 1400 includes identifying, at the apparatus and based on the plurality of measurements, first occupancy grid cells having occupancy mass corresponding to the plurality of objects. For example, the occupancy grid unit 560 may use the measurements of objects to identify the cells 930 that overlap with the surrounding regions 1010-1019. The processor 510, possibly in combination with the memory 530, may comprise means for identifying the first occupancy grid cells.

At stage 1430, the method 1400 includes identifying, at the apparatus and based on the plurality of measurements, second occupancy grid cells that are unoccupied. For example, the occupancy grid unit 560 may identify all the cells of the measurement grid that overlap with the total region 1100 (a merger of free space candidate zones) and other regions without an object. The processor 510, possibly in combination with the memory 530, may comprise means for identifying the second occupancy grid cells.

At stage 1440, the method 1400 includes updating, at the apparatus, an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells. For example, the occupancy grid unit 560 may prioritize updating occupancy parameters of occupancy cells corresponding to the total region 1100 (and other unoccupied cells) and the occupancy cells overlapping with the object-surrounding areas, e.g., over updating occupancy parameters of occluded occupancy cells, to update an occupancy grid. The processor 510, possibly in combination with the memory 530, may comprise means for updating the occupancy grid.

Implementations of the method 1400 may include one or more of the following features. In an example implementation, updating the occupancy grid comprises load balancing updating of the first occupancy grid cells and the second occupancy grid cells across a plurality of work units of at least one processor of the apparatus. For example, the occupancy grid unit 560 may distribute the load that each work unit of the processor 510 processes to update the occupancy grid. In another example implementation, updating the occupancy grid comprises dividing, of the occupancy grid, only the first occupancy grid cells and the second occupancy grid cells across a plurality of work units of at least one processor of the apparatus. For example, the occupancy grid unit 560 may distribute the load, of cells overlapping with the total region 1100 or overlapping with the surrounding regions 1010-1019, that each work unit of the processor 510 processes to update the occupancy grid. In a further example implementation, the method 1400 includes determining a quantity of the plurality of work units based on available compute capacity of the at least one processor of the apparatus, or operational design domain (ODD), or a number of object detections, or any combination of two or more thereof. The processor 510, possibly in combination with the memory 530, may comprise means for determining the quantity of the work units.

Also or alternatively, implementations of the method 1400 may include one or more of the following features. In an example implementation, updating the occupancy grid comprises updating only the occupancy parameters of the first occupancy grid cells and the second occupancy grid cells. For example, the occupancy grid unit 560 may update occupancy parameters of the cells corresponding to the total region 1100 and the surrounding regions 1010-1019 but not of other (e.g., occluded) cells. In another example implementation, the method includes identifying, as the second occupancy grid cells, cells of the occupancy grid between the apparatus and a nearest detected object for each of a plurality of azimuth sections. The processor 510, possibly in combination with the memory 530, may comprise means for identifying, as the second occupancy grid cells, cells of the occupancy grid between the apparatus and a nearest detected object for each of a plurality of azimuth sections. In another example implementation, identifying the first occupancy grid cells comprises: determining each object-occupied cell in which a detected object is disposed; and determining, for each respective object-occupied cell, a mini-grid cell of the occupancy grid that is disposed proximate to the respective object-occupied cell and that will receive occupancy mass corresponding to the detected object. For example, the occupancy grid may determine each of the cells 930 that is at least partially overlapped by a detected object, and determine a mini-grid of cells corresponding to each surrounding region that will have occupancy mass influenced by at least a respective one of the detected objects. The processor 510, possibly in combination with the memory 530, may comprise means for determining each object-occupied cell and means for determining a mini-grid cell for each respective object-occupied cell.

### IMPLEMENTATION EXAMPLES

Implementation examples are provided in the following numbered clauses.

Clause 1. An occupancy grid updating method comprising:
obtaining, at an apparatus from at least one sensor, a plurality of measurements of a plurality of objects;
identifying, at the apparatus and based on the plurality of measurements, first occupancy grid cells having occupancy mass corresponding to the plurality of objects;
identifying, at the apparatus and based on the plurality of measurements, second occupancy grid cells that are unoccupied; and
updating, at the apparatus, an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

Clause 2. The occupancy grid updating method of clause 1, wherein updating the occupancy grid comprises load balancing updating of the first occupancy grid cells and the second occupancy grid cells across a plurality of work units of at least one processor of the apparatus.

Clause 3. The occupancy grid updating method of clause 1, wherein updating the occupancy grid comprises dividing, of the occupancy grid, only the first occupancy grid cells and the second occupancy grid cells across a plurality of work units of at least one processor of the apparatus.

Clause 4. The occupancy grid updating method of clause 3, further comprising determining a quantity of the plurality of work units based on available compute capacity of the at least one processor of the apparatus, or operational design domain (ODD), or a number of object detections, or any combination of two or more thereof.

Clause 5. The occupancy grid updating method of clause 1, wherein updating the occupancy grid comprises updating only the occupancy parameters of the first occupancy grid cells and the second occupancy grid cells.

Clause 6. The occupancy grid updating method of clause 1, further comprising identifying, as the second occupancy grid cells, cells of the occupancy grid between the apparatus and a nearest detected object for each of a plurality of azimuth sections.

Clause 7. The occupancy grid updating method of clause 1, wherein identifying the first occupancy grid cells comprises:
determining each object-occupied cell in which a detected object is disposed; and
determining, for each respective object-occupied cell, a mini-grid cell of the occupancy grid that is disposed proximate to the respective object-occupied cell and that will receive occupancy mass corresponding to the detected object.

Clause 8. An apparatus comprising:
at least one memory;
at least one sensor; and
at least one processor, communicatively coupled to the at least one memory and the at least one sensor, configured to:
   obtain, from the at least one sensor, a plurality of measurements of a plurality of objects;
   identify, based on the plurality of measurements, first occupancy grid cells having occupancy mass corresponding to the plurality of objects;
   identify, based on the plurality of measurements, second occupancy grid cells that are unoccupied; and
   update an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

Clause 9. The apparatus of clause 8, wherein to update the occupancy grid, the at least one processor is configured to load balance updating of the first occupancy grid cells and the second occupancy grid cells across a plurality of work units of the at least one processor.

Clause 10. The apparatus of clause 8, wherein to update the occupancy grid, the at least one processor is configured to divide, of the occupancy grid, only the first occupancy grid cells and the second occupancy grid cells across a plurality of work units of the at least one processor.

Clause 11. The apparatus of clause 10, wherein the at least one processor is configured to determine a quantity of the plurality of work units based on available compute capacity, or operational design domain (ODD), or a number of object detections, or any combination of two or more thereof.

Clause 12. The apparatus of clause 8, wherein to update the occupancy grid, the at least one processor is configured to update only the occupancy parameters of the first occupancy grid cells and the second occupancy grid cells.

Clause 13. The apparatus of clause 8, wherein the at least one processor is configured to identify, as the second occupancy grid cells, cells of the occupancy grid between the apparatus and a nearest detected object for each of a plurality of azimuth sections.

Clause 14. The apparatus of clause 8, wherein to identify the first occupancy grid cells, the at least one processor is configured to:
determine each object-occupied cell in which a detected object is disposed; and
determine, for each respective object-occupied cell, a mini-grid cell of the occupancy grid that is disposed proximate to the respective object-occupied cell and that will receive occupancy mass corresponding to the detected object.

Clause 15. An apparatus comprising:
means for obtaining, from at least one sensor, a plurality of measurements of a plurality of objects;
means for identifying, based on the plurality of measurements, first occupancy grid cells having occupancy mass corresponding to the plurality of objects;
means for identifying, based on the plurality of measurements, second occupancy grid cells that are unoccupied; and
means for updating an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

Clause 16. The apparatus of clause 15, wherein the means for updating the occupancy grid comprise means for load balancing updating of the first occupancy grid cells and the second occupancy grid cells across a plurality of work units of at least one processor of the apparatus.

Clause 17. The apparatus of clause 15, wherein the means for updating the occupancy grid comprise means for dividing, of the occupancy grid, only the first occupancy grid cells and the second occupancy grid cells across a plurality of work units of at least one processor of the apparatus.

Clause 18. The apparatus of clause 17, further comprising means for determining a quantity of the plurality of work units based on available compute capacity of the at least one processor of the apparatus, or operational design domain (ODD), or a number of object detections, or any combination of two or more thereof.

Clause 19. The apparatus of clause 15, wherein the means for updating the occupancy grid comprise means for updating only the occupancy parameters of the first occupancy grid cells and the second occupancy grid cells.

Clause 20. The apparatus of clause 15, further comprising means for identifying, as the second occupancy grid cells, cells of the occupancy grid between the apparatus and a nearest detected object for each of a plurality of azimuth sections.

Clause 21. The apparatus of clause 15, wherein the means for identifying the first occupancy grid cells comprise:
means for determining each object-occupied cell in which a detected object is disposed; and
means for determining, for each respective object-occupied cell, a mini-grid cell of the occupancy grid that is disposed proximate to the respective object-occupied cell and that will receive occupancy mass corresponding to the detected object.

Clause 22. A non-transitory, processor-readable storage medium comprising processor-readable instructions to cause at least one processor of an apparatus to:
obtain, from at least one sensor, a plurality of measurements of a plurality of objects;
identify, based on the plurality of measurements, first occupancy grid cells having occupancy mass corresponding to the plurality of objects;
identify, based on the plurality of measurements, second occupancy grid cells that are unoccupied; and
update an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

Clause 23. The non-transitory, processor-readable storage medium of clause 22, wherein the processor-readable instructions to cause the at least one processor to update the occupancy grid comprise processor-readable instructions to cause the at least one processor to load balance updating of the first occupancy grid cells and the second occupancy grid cells across a plurality of work units of at least one processor of the apparatus.

Clause 24. The non-transitory, processor-readable storage medium of clause 22, wherein the processor-readable instructions to cause the at least one processor to update the occupancy grid comprise processor-readable instructions to cause the at least one processor to divide, of the occupancy grid, only the first occupancy grid cells and the second occupancy grid cells across a plurality of work units of at least one processor of the apparatus.

Clause 25. The non-transitory, processor-readable storage medium of clause 24, further comprising processor-readable instructions to cause the at least one processor to determine a quantity of the plurality of work units based on available compute capacity of the at least one processor, or operational design domain (ODD), or a number of object detections, or any combination of two or more thereof.

Clause 26. The non-transitory, processor-readable storage medium of clause 22, wherein the processor-readable instructions to cause the at least one processor to update the occupancy grid comprise processor-readable instructions to cause the at least one processor to update only the occupancy parameters of the first occupancy grid cells and the second occupancy grid cells.

Clause 27. The non-transitory, processor-readable storage medium of clause 22, further comprising processor-readable instructions to cause the at least one processor to identify, as the second occupancy grid cells, cells of the occupancy grid between the apparatus and a nearest detected object for each of a plurality of azimuth sections.

Clause 28. The non-transitory, processor-readable storage medium of clause 22, wherein the processor-readable instructions to cause the at least one processor to identify the first occupancy grid cells comprise processor-readable instructions to cause the at least one processor to:
determine each object-occupied cell in which a detected object is disposed; and
determine, for each respective object-occupied cell, a mini-grid cell of the occupancy grid that is disposed proximate to the respective object-occupied cell and that will receive occupancy mass corresponding to the detected object.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An occupancy grid updating method comprising:
obtaining, at an apparatus from at least one sensor, a plurality of measurements of a plurality of objects;
identifying, at the apparatus and based on the plurality of measurements, first occupancy grid cells having occupancy mass corresponding to the plurality of objects;
identifying, at the apparatus and based on the plurality of measurements, second occupancy grid cells that are unoccupied; and
updating, at the apparatus, an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

2. The occupancy grid updating method of claim 1, wherein updating the occupancy grid comprises load balancing updating of the first occupancy grid cells and the second occupancy grid cells across a plurality of work units of at least one processor of the apparatus.

3. The occupancy grid updating method of claim 1, wherein updating the occupancy grid comprises dividing, of the occupancy grid, only the first occupancy grid cells and the second occupancy grid cells across a plurality of work units of at least one processor of the apparatus.

4. The occupancy grid updating method of claim 3, further comprising determining a quantity of the plurality of work units based on available compute capacity of the at least one processor of the apparatus, or operational design domain (ODD), or a number of object detections, or any combination of two or more thereof.

5. The occupancy grid updating method of claim 1, wherein updating the occupancy grid comprises updating only the occupancy parameters of the first occupancy grid cells and the second occupancy grid cells.

6. The occupancy grid updating method of claim 1, further comprising identifying, as the second occupancy grid cells, cells of the occupancy grid between the apparatus and a nearest detected object for each of a plurality of azimuth sections.

7. The occupancy grid updating method of claim 1, wherein identifying the first occupancy grid cells comprises:
determining each object-occupied cell in which a detected object is disposed; and
determining, for each respective object-occupied cell, a mini-grid cell of the occupancy grid that is disposed proximate to the respective object-occupied cell and that will receive occupancy mass corresponding to the detected object.

8. An apparatus comprising:
at least one memory;
at least one sensor; and
at least one processor, communicatively coupled to the at least one memory and the at least one sensor, configured to:
obtain, from the at least one sensor, a plurality of measurements of a plurality of objects;
identify, based on the plurality of measurements, first occupancy grid cells having occupancy mass corresponding to the plurality of objects;
identify, based on the plurality of measurements, second occupancy grid cells that are unoccupied; and
update an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

9. The apparatus of claim 8, wherein to update the occupancy grid, the at least one processor is configured to load balance updating of the first occupancy grid cells and the second occupancy grid cells across a plurality of work units of the at least one processor.

10. The apparatus of claim 8, wherein to update the occupancy grid, the at least one processor is configured to divide, of the occupancy grid, only the first occupancy grid cells and the second occupancy grid cells across a plurality of work units of the at least one processor.

11. The apparatus of claim 10, wherein the at least one processor is configured to determine a quantity of the plurality of work units based on available compute capacity, or operational design domain (ODD), or a number of object detections, or any combination of two or more thereof.

12. The apparatus of claim 8, wherein to update the occupancy grid, the at least one processor is configured to update only the occupancy parameters of the first occupancy grid cells and the second occupancy grid cells.

13. The apparatus of claim 8, wherein the at least one processor is configured to identify, as the second occupancy grid cells, cells of the occupancy grid between the apparatus and a nearest detected object for each of a plurality of azimuth sections.

14. The apparatus of claim 8, wherein to identify the first occupancy grid cells, the at least one processor is configured to:
determine each object-occupied cell in which a detected object is disposed; and
determine, for each respective object-occupied cell, a mini-grid cell of the occupancy grid that is disposed proximate to the respective object-occupied cell and that will receive occupancy mass corresponding to the detected object.

15. An apparatus comprising:
means for obtaining, from at least one sensor, a plurality of measurements of a plurality of objects;
means for identifying, based on the plurality of measurements, first occupancy grid cells having occupancy mass corresponding to the plurality of objects;
means for identifying, based on the plurality of measurements, second occupancy grid cells that are unoccupied; and
means for updating an occupancy grid containing the first occupancy grid cells, the second occupancy grid cells, and third occupancy grid cells, by prioritizing updating occupancy parameters of the first occupancy grid cells and the second occupancy grid cells over updating occupancy parameters of the third occupancy grid cells.

16. The apparatus of claim 15, wherein the means for updating the occupancy grid comprise means for load balancing updating of the first occupancy grid cells and the second occupancy grid cells across a plurality of work units of at least one processor of the apparatus.

17. The apparatus of claim 15, wherein the means for updating the occupancy grid comprise means for dividing, of the occupancy grid, only the first occupancy grid cells and the second occupancy grid cells across a plurality of work units of at least one processor of the apparatus.

18. The apparatus of claim 17, further comprising means for determining a quantity of the plurality of work units based on available compute capacity of the at least one processor of the apparatus, or operational design domain (ODD), or a number of object detections, or any combination of two or more thereof.

19. The apparatus of claim 15, wherein the means for updating the occupancy grid comprise means for updating only the occupancy parameters of the first occupancy grid cells and the second occupancy grid cells.

20. The apparatus of claim 15, further comprising means for identifying, as the second occupancy grid cells, cells of the occupancy grid between the apparatus and a nearest detected object for each of a plurality of azimuth sections.
